(19) United States
(12) Patent Application Publication
(10) Pub. No.: US 2022/0299926 A1
(43) Pub. Date: Sep. 22, 2022

(54) IMAGE FORMING APPARATUS

(71) Applicant: TOSHIBA TEC KABUSHIKI KAISHA, Tokyo (JP)

(72) Inventor: Naofumi Soga, Sunto Shizuoka (JP)

(21) Appl. No.: 17/205,108

(22) Filed: Mar. 18, 2021

(51) Int. Cl. G03G 15/00; B65H 1/14; B65H 3/06

(52) U.S. Cl. CPC G03G 15/6514; G03G 15/6511; B65H 1/14; B65H 3/0684

(57) ABSTRACT

An image forming unit forms an image on a sheet. A sheet feed unit supplies the sheet to the image forming unit. A sheet tray is provided in the sheet feed unit. The sheet is placed on the sheet tray. An elevating plate is arranged on the sheet tray. The elevating plate can be ascended and descended between a descended position where the sheet is set and an ascending position higher than the descended position. A moving member can move between a first position in which the elevating plate is arranged in the descended position and a second position in which the elevating plate can move to the ascending position. A shielding member is interlocked with the ascending and descending operation of the elevating plate. The shielding member shields the moving member when the elevating plate is located at the descended position.

### FIELD

Embodiments described herein relate generally to an image forming apparatus and a sheet handling mechanism.

### BACKGROUND

An image forming apparatus is provided with a sheet feed unit such as a manual sheet feed. The sheet feed unit includes an elevating plate that pushes up the sheet placed on the sheet tray from below to the position of the pickup roller. The elevating plate is ascended and descended by a movable portion such as a cam. Since the movable portion is exposed when the sheet feed unit is in use, it is necessary to prevent the user's finger from entering the exposed portion of the movable portion. For this reason, the image forming apparatus is required to reduce the opening around the movable portion.

### DESCRIPTION OF THE DRAWINGS

FIG. 1 is a schematic configuration diagram of an image forming apparatus of a first embodiment;

FIG. 2 is a perspective view of a manual feed tray (ascending position of the elevating plate) of the first embodiment;

FIG. 3 is an external perspective view of the manual feed tray of the first embodiment;

FIG. 4 is a perspective view of the manual feed tray (descended position of the elevating plate) of the first embodiment;

FIG. 5 is a perspective view of an elevating mechanism of the first embodiment;

FIG. 6 is a perspective view of a cam of the elevating mechanism of the first embodiment;

FIG. 7 is a schematic diagram for illustrating the descended position of an elevating plate of the first embodiment;

FIG. 8 is a schematic diagram for illustrating the ascending position of the elevating plate of the first embodiment;

FIG. 9 is a schematic diagram for illustrating the position of the cam (cam-down position) in the descended position of the elevating plate of the first embodiment;

FIG. 10 is a schematic diagram for illustrating the position of the cam (cam-up position) in the ascending position of the elevating plate of the first embodiment;

FIG. 11 is a perspective view for illustrating the cam-up position in the ascending position of the elevating plate of the first embodiment;

FIG. 12 is a perspective view for illustrating a state in which the elevating plate is pushed down against the biasing force of a biasing member from the state of the cam-up position in the ascending position of the elevating plate of the first embodiment;

FIG. 13 is a perspective view for illustrating the position of a shutter in the state of the cam-up position in the ascending position of the elevating plate of the first embodiment;

FIG. 14 is a perspective view for illustrating the position of the shutter in the state of the cam-up position in the descended position of the elevating plate of the first embodiment;

FIG. 15 is a schematic diagram for illustrating the position of the shutter with respect to the gap in the ascending position of the elevating plate of the first embodiment;

FIG. 16 is a schematic diagram for illustrating the position of the shutter with respect to the gap in the descended position of the elevating plate of the first embodiment; and

FIG. 17 is a schematic diagram for illustrating the position of a shutter with respect to the gap in the descended position of an elevating plate of a second embodiment.

### DETAILED DESCRIPTION

In general, according to one embodiment, an image forming apparatus includes an image forming unit, a sheet feed unit, a sheet tray, an elevating plate, a moving member, and a shielding member. The image forming unit forms an image on a sheet. The sheet feed unit supplies the sheet to the image forming unit. The sheet tray is provided in the sheet feed unit. The sheet is placed on the sheet tray. The elevating plate is arranged on the sheet tray. The elevating plate can be ascended and descended between the descended position where the sheet is set and the ascending position higher than the descended position. The moving member can move between a first position where the elevating plate is arranged in the descended position and a second position where the elevating plate can move to the ascending position. The shielding member is interlocked with the ascending and descending operation of the elevating plate. The shielding member shields the moving member when the elevating plate is located at the descended position.

Hereinafter, an image forming apparatus of a first embodiment will be described with reference to the drawings.

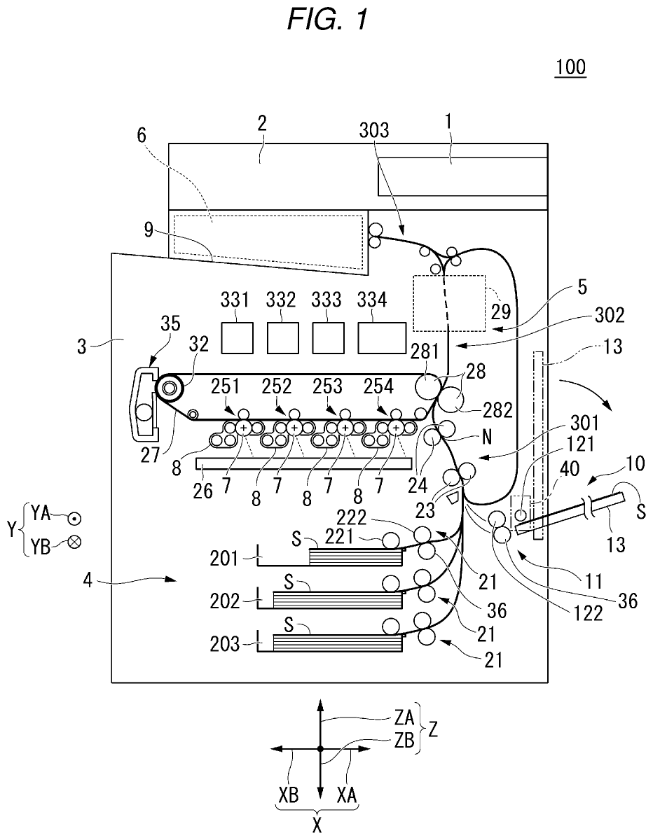

FIG. 1 is a schematic configuration diagram of the image forming apparatus of the first embodiment.

As shown in FIG. 1, an image forming apparatus 100 includes a control panel 1, a scanner unit 2, a printer unit 3, a sheet supply unit 4, a conveyance unit 5, a manual feed unit 10 (sheet feed unit), and a control unit 6. The image forming apparatus 100 forms an image on a sheet-like recording medium (hereinafter referred to as “sheet”) such as paper.

Hereinafter, when referring to the relative position in the image forming apparatus 100, an XA direction, an XB direction, a YA direction, a YB direction, a ZA direction, and a ZB direction shown in the drawings may be used. The XA direction is a direction from left to right when standing in front of the image forming apparatus 100 (front side of the paper surface of FIG. 1). The XB direction is a direction opposite to the XA direction. The YA direction is a direction from the back surface to the front surface of the image forming apparatus 100. The YB direction is a direction opposite to the YA direction. The ZA direction is a vertically upward direction. The ZB direction is a vertically downward direction. When the orientation of the XA (YA, ZA) direction or the XB (YB, ZB) direction does not matter, or when both directions are included, the direction is simply referred to as the X (Y, Z) direction.

Hereinafter, a plane having a normal in the X direction is referred to as a YZ plane, a plane having a normal in the Y direction is referred to as a ZX plane, and a plane having a normal in the Z direction is referred to as an XY plane. The ZX plane is a plane parallel to the conveyance direction of a sheet S described later in the image forming apparatus 100. The XY plane is a horizontal plane.

The control panel 1 operates the image forming apparatus 100 by the user's operation.

The scanner unit 2 reads the image information of the object to be copied based on brightness and darkness of light. The scanner unit 2 outputs the read image information to the printer unit 3.

The printer unit 3 forms an image on the sheet S based on the image information from the scanner unit 2 or the outside.

The printer unit 3 forms an output image (toner image) with a developer containing toner. The printer unit 3 transfers the toner image onto the surface of the sheet S. The printer unit 3 applies heat and pressure to the toner image on the surface of the sheet S to fix the toner image onto the sheet S.

The sheet supply unit 4 supplies sheets S one by one to the printer unit 3 at the timing when the printer unit 3 forms the toner image.

The sheet supply unit 4 includes sheet feed cassettes 201, 202, and 203 and a plurality of cassette sheet feed units 21.

The sheet feed cassettes 201, 202, and 203 store sheets S of various sizes.

The plurality of cassette sheet feed units 21 are arranged above the end portions of the sheet feed cassettes 201, 202, and 203 in the XA direction, respectively. Each cassette sheet feed unit 21 includes a pickup roller 221 and a sheet feed roller 222, and a separation roller 36.

Each pickup roller 221 conveys the sheet S necessary for image formation from the sheet feed cassettes 201, 202, and 203 to the nip portion between the sheet feed roller 222 and the separation roller 36.

Each sheet feed roller 222 conveys the sheet S conveyed to the nip portion to the conveyance unit 5.

Each separation roller 36 separates one sheet S when a plurality of sheets S are conveyed.

The conveyance unit 5 includes conveyance rollers 23 and registration rollers 24. The conveyance unit 5 conveys the sheet S supplied from the sheet supply unit 4 to the registration rollers 24.

The registration rollers 24 convey the sheet S according to the timing at which the printer unit 3 transfers the toner image to the sheet S.

The conveyance rollers 23 abut the tip of the sheet S in the conveyance direction against the nip N of the registration rollers 24. The conveyance rollers 23 adjust the position of the tip of the sheet S in the conveyance direction by bending the sheet S.

The registration rollers 24 align the tip of the sheet S sent out from the conveyance rollers 23 with the nip N. Further, the registration rollers 24 convey the sheet S to a transfer unit 28 side, which will be described later.

The conveyance unit 5 includes conveyance paths 301, 302, and 303. The conveyance paths 301, 302, and 303 will be described after explaining the other configurations of the printer unit 3.

The printer unit 3 includes image forming units 251, 252, 253, and 254, an exposure unit 26, an intermediate transfer belt 27, the transfer unit 28, a fixing device 29, and a transfer belt cleaning unit 35.

The image forming units 251, 252, 253, and 254 are arranged in this order in the XA direction. Each of the image forming units 251, 252, 253, and 254 forms a toner image to be transferred to the sheet S on the intermediate transfer belt 27. The image forming units 251, 252, 253, and 254 each include a photoconductor drum 7. The image forming units 251, 252, 253, and 254 form yellow, magenta, cyan, and black toner images on the respective photoconductor drums 7.

A charger, a developing device 8, a primary transfer roller, a cleaning unit, and a static eliminator are arranged around each photoconductor drum 7. The primary transfer roller faces the photoconductor drum 7. The intermediate transfer belt 27 is sandwiched between the primary transfer roller and the photoconductor drum 7. The exposure unit 26 is arranged below the charger and the developing device 8.

Toner cartridges 331, 332, 333, and 334 are arranged above the image forming units 251, 252, 253, and 254. The toner cartridges 331, 332, 333, and 334 contain yellow, magenta, cyan, and black toners, respectively.

The toners of the toner cartridges 331, 332, 333, and 334 are supplied to the image forming units 251, 252, 253, and 254 by a toner supply pipe (not shown).

The exposure unit 26 irradiates the surface of each charged photoconductor drum 7 with a laser beam. The laser beam is controlled to emit light based on the image information. The exposure unit 26 can also adopt a configuration that emits LED light instead of laser light. In the example shown in FIG. 1, the exposure unit 26 is arranged below the image forming units 251, 252, 253, and 254. Image information corresponding to yellow, magenta, cyan, and black is supplied to the exposure unit 26, respectively. The exposure unit 26 forms an electrostatic latent image based on image information on the surface of each photoconductor drum 7.

The intermediate transfer belt 27 is formed by an endless belt. Tension is applied to the intermediate transfer belt 27 by a plurality of rollers that are in contact with the inner peripheral surface. The intermediate transfer belt 27 is stretched flat along the X direction. The inner peripheral surface of the intermediate transfer belt 27 abuts on a support roller 281 at the most distant position in the XA direction in the tensioning direction. The inner peripheral surface of the intermediate transfer belt 27 abuts on a transfer belt roller 32 at the most distant position in the XB direction in the tensioning direction.

The support roller 281 constitutes a part of the transfer unit 28 described later. The support roller 281 guides the intermediate transfer belt 27 to the secondary transfer position.

The transfer belt roller 32 guides the intermediate transfer belt 27 to the cleaning position.

The image forming units 251, 252, 253, and 254 excluding the primary transfer roller are arranged in this order in the XA direction on the depicted lower surface side of the intermediate transfer belt 27. The image forming units 251, 252, 253, and 254 are arranged at intervals from each other in the region between the transfer belt roller 32 and the support roller 281.

A transfer bias is applied to the respective primary transfer rollers of the image forming units 251, 252, 253, and 254 when the toner image reaches the primary transfer position. Each primary transfer roller transfers (primary transfer) the toner image on the surface of each photoconductor drum 7 onto the intermediate transfer belt 27.

In the intermediate transfer belt 27, the transfer unit 28 is arranged at a position adjacent to the image forming unit 254.

The transfer unit 28 includes the support roller 281 and a secondary transfer roller 282. The secondary transfer roller 282 and the support roller 281 sandwich the intermediate transfer belt 27. The position where the secondary transfer roller 282 and the intermediate transfer belt 27 come into contact with each other is the secondary transfer position.

The transfer unit 28 transfers the charged toner image on the intermediate transfer belt 27 onto the surface of the sheet S at the secondary transfer position. The transfer unit 28 applies a transfer bias to the secondary transfer position. The transfer unit 28 transfers the toner image on the intermediate transfer belt 27 to the sheet S by the transfer bias.

The fixing device 29 applies heat and pressure to the sheet S. The fixing device 29 fixes the toner image transferred to the sheet S by heat and pressure. The fixing device 29 is arranged above the transfer unit 28.

The transfer belt cleaning unit 35 faces the transfer belt roller 32. The transfer belt cleaning unit 35 sandwiches the intermediate transfer belt 27. The transfer belt cleaning unit 35 scrapes off the toner on the surface of the intermediate transfer belt 27.

The conveyance paths 301 and 302 that convey the sheet S from the bottom to upward are formed in this order between the registration rollers 24 and the transfer unit 28 and between the transfer unit 28 and the fixing device 29, respectively.

Each of the conveyance paths 301, 302, and 303 includes a conveyance guide unit that faces each other with the sheet S sandwiched therebetween, and a conveyance roller that is provided as needed.

The manual feed unit 10 supplies the sheet S on which the image is formed to the printer unit 3. The manual feed unit 10 includes a manual sheet feed unit 11, a manual feed tray 13 (sheet tray), and an elevating mechanism 40.

The manual feed tray 13 can rotate about an axis extending in the Y direction. When the manual feed tray 13 is used, the manual feed tray 13 is opened by being rotated clockwise as shown by a solid line. Sheets S of various sizes can be placed on the opened manual feed tray 13.

When the manual feed tray 13 is not used, the manual feed tray 13 is rotated counterclockwise as shown by the two-dot chain line and is housed in the side portion of the printer unit 3 in the XA direction.

The manual sheet feed unit 11 separately feeds the sheet S placed on the manual feed tray 13 and conveys the sheet toward the registration rollers 24. The manual sheet feed unit 11 includes a pickup roller 121, a sheet feed roller 122, and the separation roller 36.

The pickup roller 121 and the sheet feed roller 122 in the manual sheet feed unit 11 have the same configurations as the pickup roller 221 and the sheet feed roller 222 in the cassette sheet feed unit 21.

The separation roller 36 in the manual sheet feed unit 11 has the same configuration as the separation roller 36 in the cassette sheet feed unit 21 except that the separation roller 36 comes into contact with the sheet feed roller 122.

Next, the detailed configuration of the manual feed tray 13 will be described.

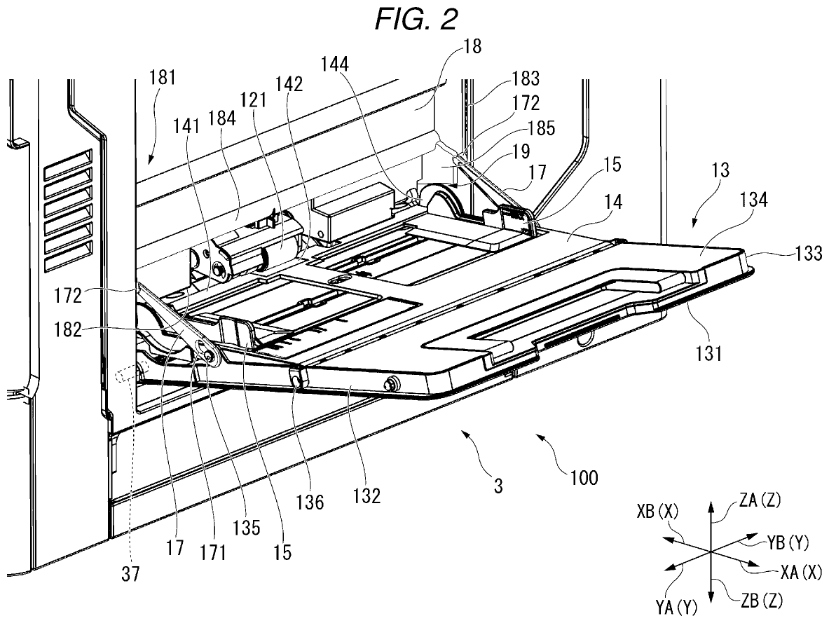

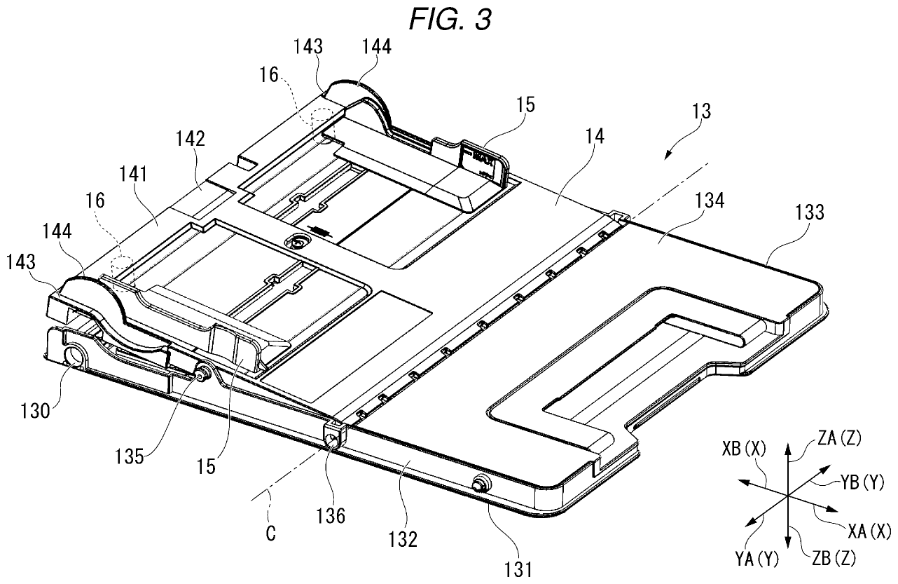

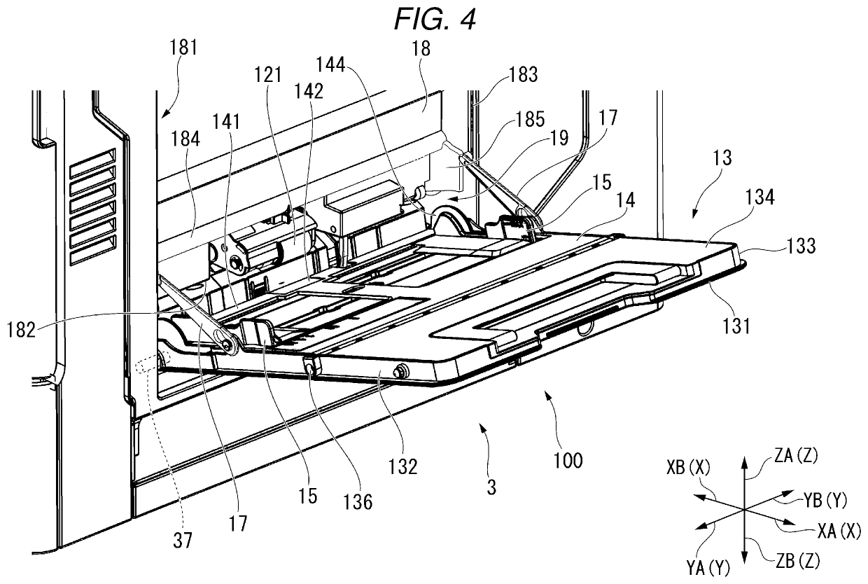

FIG. 2 is a perspective view of the manual feed tray (ascending position of the elevating plate) of the first embodiment. FIG. 3 is an external perspective view of the manual feed tray of the first embodiment. FIG. 4 is a perspective view of the manual feed tray (descended position of the elevating plate) of the first embodiment.

As shown in FIG. 2, the manual feed tray 13 has a flat plate shape as a whole. The manual feed tray 13 has a size that can be stored in a tray storage unit 181 of a side cover 18 that covers the right side surface of the printer unit 3 of the image forming apparatus 100. The tray storage unit 181 is recessed in the XB direction from the surface of the side cover 18. The outer shape of the tray storage unit 181 seen from the XB direction is a rectangular shape having substantially the same size as the manual feed tray 13.

A sheet feed opening 182 through which the sheet S can pass is formed in the lower portion of the tray storage unit 181. The pickup roller 121 projects in the XA direction at the center of the upper portion of the sheet feed opening 182 in the Y direction.

At the lower end portion of the tray storage unit 181, a rotary support shaft 37 projects from each inner surface of the tray storage unit 181 in the Y direction from the apparatus main body covered with the side cover 18. However, FIG. 2 shows only the rotary support shaft 37 protruding in the YB direction from the inner surface of the tray storage unit 181 in the YA direction.

Each rotary support shaft 37 extends coaxially with an axis extending in the Y direction. Each rotary support shaft 37 is fitted to a bearing portion 130 (see FIG. 3), which will be described later, of the manual feed tray 13. Therefore, the manual feed tray 13 is rotatably fixed to the apparatus main body about each rotary support shaft 37.

Each inner wall of the side cover 18 in the Y direction is provided with a guide groove 183 extending in the Z direction. However, FIG. 2 shows only the guide groove 183 on the inner wall in the YB direction. A link 17 described later is engaged with each guide groove 183.

Each link 17 holds the manual feed tray 13 at a predetermined angle with respect to the horizontal plane (XY plane) in a state where the manual feed tray 13 is opened outward from the tray storage unit 181. Each link 17 connects each side surface of the manual feed tray 13 in the Y direction with each guide groove 183. Each link 17 includes a connecting hole 171 and a connecting pin 172 at both ends in the longitudinal direction.

The connecting hole 171 connects a mounting protrusion 135, which will be described later, of the manual feed tray 13.

The connecting pin 172 is movably connected to each guide groove 183 in the Z direction.

With such a configuration, the manual feed tray 13 can rotate between the closed state and the open state. The closed state is a state in which the manual feed tray 13 is stored inside the tray storage unit 181 in a posture along the vertical plane. The open state is a state in which the manual feed tray 13 is opened toward the outside of the tray storage unit 181 in the XA direction at an angle defined by the link 17 with respect to the horizontal plane.

Hereinafter, unless otherwise specified, the manual feed tray 13 in the open state will be described.

As shown in FIG. 3, the manual feed tray 13 includes a bottom plate 131, a front side plate 132, a rear side plate 133, an upper plate 134, an elevating plate 14, a guide fence 15, and a biasing member 16.

The bottom plate 131 forms the lower surface in the open state. The bottom plate 131 is substantially flush with the side cover 18 outside the tray storage unit 181 in the closed state. In the closed state, the bottom plate 131, together with the side cover 18, forms a part of the right side surface of the image forming apparatus 100.

The front side plate 132 projects upward from the end portion of the bottom plate 131 in the YA direction. The front side plate 132 includes the bearing portion 130, a mounting protrusion 135, and a rotary support shaft 136.

The bearing portion 130 supports the rotary support shaft 37 (see FIG. 2) protruding in the YB direction from the inner surface of the tray storage unit 181 in the YA direction. The bearing portion 130 is formed near the tip of the front side plate 132 in the XB direction.

The mounting protrusion 135 is engaged with the connecting hole 171 (see FIG. 2) of the link 17. The mounting protrusion 135 projects in the YA direction from a position distant from the bearing portion 130 in the XA direction.

The rotary support shaft 136 rotatably supports the elevating plate 14, which will be described later, around a central axis C of the rotary support shaft 136. The rotary support shaft 136 projects from the front side plate 132 in the YB direction.

The rear side plate 133 projects upward from the end portion of the bottom plate 131 in the YB direction. The rear side plate 133 has a shape plane-symmetrical with the front side plate 132, with the ZX plane including the central axis in the Y direction of the bottom plate 131 as a symmetrical plane. Therefore, although not visible in FIG. 3, the rear side plate 133 includes the bearing portion 130, a mounting protrusion 135, and the rotary support shaft 136 on the front side plate 132, and the bearing portion 130, a mounting protrusion 135, and the rotary support shaft 136 provided plane-symmetrically.

The upper plate 134 covers the bottom plate 131 located in the XA direction from each rotary support shaft 136 from above. The upper plate 134 is arranged at the same height as the upper ends of the front side plate 132 and the rear side plate 133.

The elevating plate 14 and the upper plate 134 form a mounting surface on which the sheet S (not shown) is mounted. The elevating plate 14 is arranged inside the front side plate 132 and the rear side plate 133 in the Y direction from the tip of the upper plate 134 in the XB direction to the tip of the bottom plate 131 in the XB direction. The outer shape of the elevating plate 14 seen from above is substantially rectangular.

A flat tip mounting surface 141 long in the Y direction is formed at the tip portion of the elevating plate 14 in the XB direction. A friction pad 142 that increases the frictional force with the sheet S is arranged at the center of the tip mounting surface 141 in the longitudinal direction. The friction pad 142 is provided at a position capable of coming into contact with the pickup roller 121. The friction pad 142 suppresses double feeding of the lowest sheet S placed on the manual feed tray 13.

The end portion of the elevating plate 14 in the XA direction is rotatably supported by each rotary support shaft 136. In the elevating plate 14, the biasing member 16 is arranged between the back side of the tip mounting surface 141 and the bottom plate 131.

The configuration of the biasing member 16 pushes up the elevating plate 14 in the direction in which the elevating plate 14 is separated from the bottom plate 131. Examples of the biasing member 16 include a spring and an elastic member.

In this embodiment, a compression coil spring is provided as the biasing member 16. The biasing member 16 is arranged near both ends in the Y direction below the tip mounting surface 141. The biasing force of the biasing member 16 has a magnitude such that when the loadable sheet S is set on the elevating plate 14, the uppermost sheet S comes into contact with the pickup roller 121 and a frictional force capable of feeding the uppermost sheet S between the uppermost sheet S and the pickup roller 121 is generated.

A pair of guide fences 15 are provided in the region of the elevating plate 14 adjacent to the tip mounting surface 141 in the XA direction. The pair of guide fences 15 align the direction of the sheet S in the X direction with both end portions of the sheet S placed on the elevating plate 14 in the Y direction sandwiched therebetween.

Each of the pair of guide fences 15 includes a protrusion extending in the X direction above the elevating plate 14. The height of each guide fence 15 is higher than the total thickness of the number of sheets S that can be loaded on the manual feed tray 13. Each guide fence 15 is supported by the elevating plate 14 so as to be movable in the Y direction. The distance between the protrusions of each guide fence 15 in the Y direction can be changed by the user.

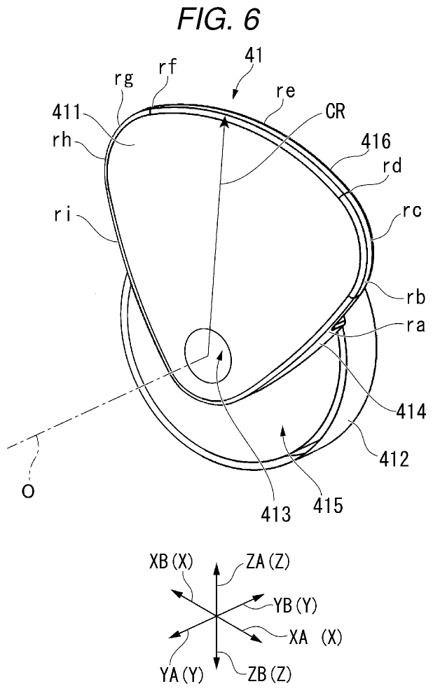

In the elevating plate 14, cam contact surfaces 143 are formed at both end portions in the Y direction at the tip portion in the XB direction. A cam plate portion 411 (see FIG. 6) of a pressing member 41 (moving member) described later abuts on the cam contact surface 143. The shape of the cam contact surface 143 is not particularly limited as long as the elevating plate 14 can be pushed down toward the bottom plate 131 by the pressing force from the cam plate portion 411 described later. In the example shown in FIG. 3, each cam contact surface 143 is a flat surface along the tip mounting surface 141.

In the present embodiment, a plate-shaped protrusion 144 is provided between each cam contact surface 143 and the tip mounting surface 141, respectively. Each plate-shaped protrusion 144 has a plate shape parallel to the front side plate 132 and the rear side plate 133. Each plate-shaped protrusion 144 projects in a chevron shape above the elevating plate 14. In the X direction, each plate-shaped protrusion 144 extends from the tip portion of the elevating plate 14 in the XB direction to the range extending to the tip portion of the guide fence 15 in the XB direction.

With such a configuration, in the manual feed tray 13 alone, the tip portion of the elevating plate 14 biased by the biasing member 16 in the XB direction projects upward from the upper ends of the front side plate 132 and the rear side plate 133. When an external force toward the bottom plate 131 acts on each cam contact surface 143, the elevating plate 14 descends toward the bottom plate 131. At the lowest position of the elevating plate 14, the upper surface of the elevating plate 14 is flush with the upper plate 134.

The arrangement of the elevating plate 14 lowered to the lowest position is hereinafter referred to as a descended position. FIG. 4 shows the manual feed tray 13 in which the elevating plate 14 is moved to the descended position.

The arrangement in which the XB direction end portion of the elevating plate 14 is higher than the descended position with respect to the bottom plate 131 is referred to as an ascending position. In the manual feed tray 13 alone shown in FIG. 3, the highest position of the ascending position of the elevating plate 14 from the bottom plate 131 is higher than the height from the bottom plate 131 to the pickup roller 121 in the state of being attached to the printer unit 3. However, as shown in FIG. 2, the raised friction pad 142 comes into contact with the pickup roller 121 in the state of being attached to the printer unit 3. Therefore, the ascending position of the elevating plate 14 is limited to the lower side of the position where the friction pad 142 hits the lower end of the pickup roller 121.

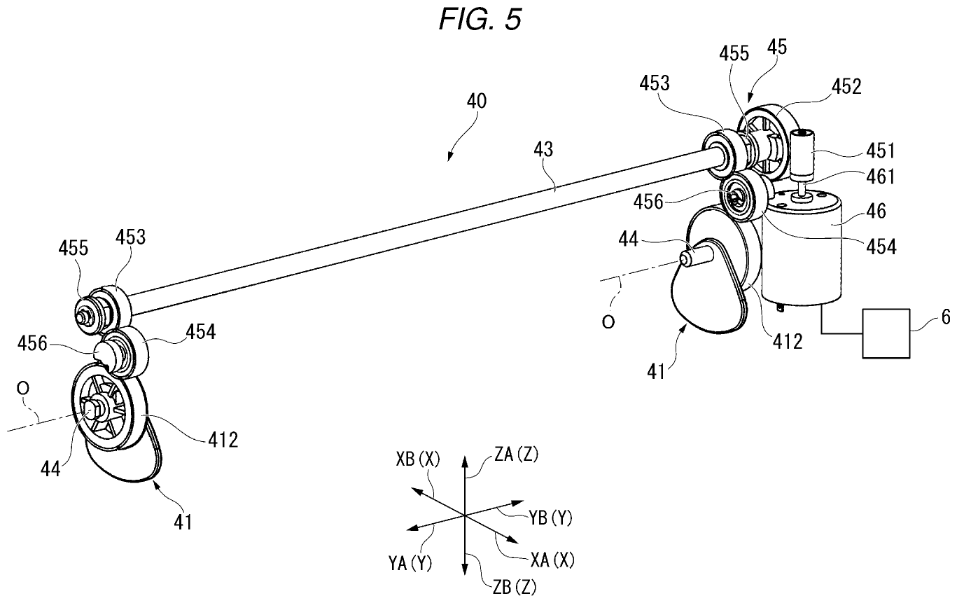

In the manual feed tray 13 in the open state, the elevating plate 14 is usually arranged at the descended position by the elevating mechanism 40 (see FIG. 5) described later. At this time, the user can place the sheet S on the elevating plate 14 and the upper plate 134 of the manual feed tray 13. For example, the sheet S can be placed up to a thickness corresponding to the distance from the friction pad 142 in the descended position to the lower end of the pickup roller 121.

As shown in FIG. 1, the elevating mechanism 40 is provided in the apparatus main body of the printer unit 3. The elevating mechanism 40 switches the elevating plate 14 between the descended position and the ascending position when the manual feed tray 13 is open.

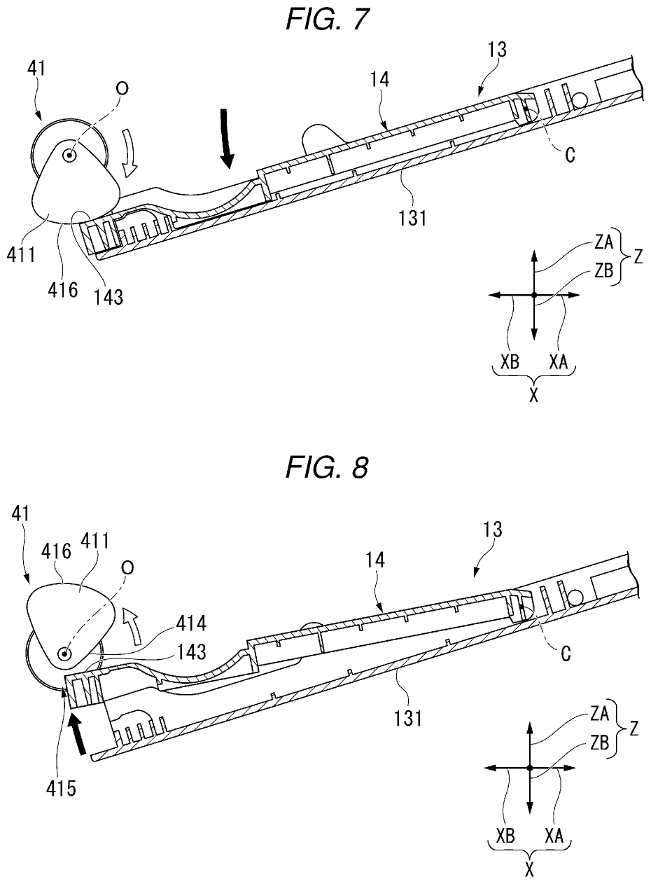

FIG. 5 is a perspective view of the elevating mechanism of the first embodiment. FIG. 6 is a perspective view of the cam of the elevating mechanism of the first embodiment. FIG. 7 is a schematic diagram for illustrating the descended position of the elevating plate of the first embodiment. FIG. 8 is a schematic diagram for illustrating the ascending position of the elevating plate of the first embodiment.

As shown in FIG. 5, the elevating mechanism 40 includes the pressing member 41, a drive motor 46, and a drive transmission unit 45.

The pressing member 41 comes into contact with each cam contact surface 143 (see FIG. 7) of the elevating plate 14 to regulate the height of the elevating plate 14. Therefore, the pressing member 41 is provided above each cam contact surface 143. When it is necessary to distinguish each pressing member 41, the pressing member 41 on the front side (YA direction side) is referred to as the front pressing member 41, and the pressing member 41 on the rear side (YB direction side) is referred to as the rear pressing member 41.

The front pressing member 41 and the rear pressing member 41 have shapes that are plane-symmetric with respect to the ZX plane at the center of their respective arrangement positions. Therefore, in the following, an example of the rear pressing member 41 will be described. Regarding the shape of the front pressing member 41, the YB direction may be read as the YA direction in the following description of the rear pressing member 41.

As shown in FIG. 6, the rear pressing member 41 includes the cam plate portion 411 (cam) and a gear portion 412.

The gear portion 412 receives a driving force from the drive transmission unit 45 described later. For example, the gear portion 412 is a spur gear. A bearing portion 413 penetrates the central portion of the gear portion 412 in the Y direction.

A rotary support shaft 44 shown in FIG. 5 is inserted into the bearing portion 413. The gear portion 412 can rotate around the central axis O of the rotary support shaft 44. The rotary support shaft 44 projects in the YA direction from, for example, the rear side plate (not shown) in the apparatus main body adjacent to the gear portion 412 in the YB direction. The length of the rotary support shaft 44 is a length capable of penetrating the rear pressing member 41 in the thickness direction.

As shown in FIG. 6, the cam plate portion 411 is provided at the end portion of the gear portion 412 in the YA direction. The cam plate portion 411 includes a stepped portion 414 that curves outward in the radial direction from the central portion of the gear portion 412 when viewed from the YB direction. A step portion 414 is a curved surface extending along the outer shape of the cam plate portion 411. A recess 415 is formed in the region between the step portion 414 and the gear portion 412. The recess 415 is recessed in the YB direction with respect to the cam plate portion 411. The end face of the gear portion 412 in the YA direction is exposed in the recess 415.

The cam plate portion 411 extends outward in the radial direction from the central portion of the gear portion 412, and the tip thereof projects outward in the radial direction. The cam plate portion 411 is formed in a fan-shaped range including the bearing portion 413 inside the gear portion 412 in the radial direction. The bearing portion 413 penetrates the cam plate portion 411 in the plate thickness direction.

The end surface of the radially outwardly protruding portion of the gear portion 412 in the cam plate portion 411 is the cam surface 416. The shape of the cam surface 416 seen from the YB direction is a curved surface represented by a curve ra, rb, rc, rd, re, rf, rg, rh, ri (hereinafter referred to as a curve [ra-ri]). The points ra, rb, . . . , ri on the curve [ra-ri] are arranged in this order counterclockwise with respect to the central axis O when viewed from the YB direction. The curve [ra-ri] is not particularly limited to a line-symmetrical shape. However, in the present embodiment, the curve [ra-ri] is line-symmetric with respect to the straight line passing through the central axis O and the point re (the bisector of the cam).

The distance (radius) from the central axis O to the cam surface 416 on a plane orthogonal to the central axis O and passing through the cam surface 416 is referred to as a cam radius CR. In the following, an example of the shape of the curve [ra-ri] will be described based on the change in the cam radius CR when advancing counterclockwise at an equal angle when viewed from the YB direction (hereinafter, simply referred to as “to advance”).

The cam radius CR is substantially equal to the outer radius of the gear portion 412 at the point ra and the point ri. The cam radius CR increases steeply as advancing from the point ra to the point rb. The increase rate of the cam radius CR gradually decreases as advancing from the point rb to the point rc. The increase rate of the cam radius CR gradually decreases as advancing from the point rc to the point rd. The cam radius CR is constant as advancing from the point rd to the point rf. In this case, the curve rd, re, rf is an arc centered on the central axis O. The central angle (∠rdOrf) of this arc is about 55 degrees. The change of the cam surface 416 from the point rf to the point ri is the same as the change when advancing clockwise from the point ri to the point rf at an equal angle.

However, the cam radius CR may gradually increase as advances from the point rd to the point re and may gradually decrease as advancing from the point re to the point rf. Here, the point re is a point that bisects the cam surface 416 between the point rd and the point rf.

In the present embodiment, the cam surface 416 is smoothly curved and continuous at the points ra, . . . , ri.

Due to the shape of the cam surface 416, the outer shape of the cam plate portion 411 when viewed from the YB direction is a fan shape that bulges outward in the radial direction from the gear portion 412 as a whole. However, rounded corners are formed at both end portions (points rb to rd and points rf to rh) of the cam plate portion 411 protruding from the gear portion 412 in the circumferential direction.

The cam radius CR is the maximum at least at the point re.

As shown in FIG. 5, the drive motor 46 is a motor that supplies a rotational driving force to the drive transmission unit 45, which will be described later, by rotating the motor shaft 461. The drive motor 46 is fixed to the apparatus main body (not shown) in the printer unit 3 via a support member (not shown). For example, the motor shaft 461 extends from the drive motor 46 in the ZA direction.

The drive motor 46 and the drive transmission unit 45 are used to swing the pressing member 41. The drive motor 46 is communicably connected to the control unit 6.

The type of the drive motor 46 is not particularly limited as long as each pressing member 41 can swing in cooperation with the drive transmission unit 45. For example, the drive transmission unit 45 may or may not include a swing mechanism that converts the rotation of the motor shaft 461 into a swing motion. The swing mechanism can be formed, for example, by a cam, a link, or a combination thereof.

Below, as shown in FIG. 5, an example in which the drive transmission unit 45 does not include a swing mechanism will be described. In this case, as the drive motor 46, a motor in which the motor shaft 461 is forwarded and reversed is used. The type of the drive motor 46 is not particularly limited as long as the motor shaft 461 can be forwarded and reversed according to the control signal from the control unit 6. For example, as the drive motor 46, a DC motor, a stepping motor, or the like may be used.

However, when the drive transmission unit 45 includes a swing mechanism, the rotation direction of the drive motor 46 may be one direction.

The drive transmission unit 45 transmits the rotation of the motor shaft 461 to the pressing member 41. The configuration of the drive transmission unit 45 is not particularly limited as long as the rotation can be transmitted. In the example shown in FIG. 5, the drive transmission unit 45 is configured by a gear transmission mechanism.

The drive transmission unit 45 includes a first gear 451, a second gear 452, a rotary shaft 43, a third gear 453, and a fourth gear 454.

The first gear 451 is a worm gear fixed to the motor shaft 461.

The second gear 452 is a worm wheel that meshes with the first gear 451. The second gear 452 is rotatable about an axis extending in the Y direction.

The rotary shaft 43 extends in the Y direction. The rotary shaft 43 is a rotary shaft that transmits the rotation of the second gear 452. The rotary shaft 43 has a length that penetrates the front side plate (not shown, the same applies hereinafter) and the rear side plate (not shown, the same applies hereinafter) facing in the Y direction. The rotary shaft 43 is rotatably supported by bearings 455 arranged on the front side plate and the rear side plate of the apparatus main body of the printer unit 3, respectively.

The third gear 453 and the fourth gear 454 transmit the rotation of the rotary shaft 43 to the front pressing member 41 and the rear pressing member 41. Therefore, as the third gears 453 and the fourth gears 454, a third gear 453 and a fourth gear 454 on the rear side (YB direction side) of the front side plate and a third gear 453 and a fourth gear 454 on the front side (YA direction side) of the rear side plate are arranged.

The number of teeth and modules of each third gear 453 are equal to each other. The number of teeth and modules of each fourth gear 454 are equal to each other. Hereinafter, when it is necessary to distinguish each third gear 453, the third gear 453 on the rear side (YB direction side) of the front side plate is referred to as the front third gear 453, and the third gear 453 on the front side (YA direction side) of the rear side plate is referred to as the rear third gear 453. When it is necessary to distinguish each fourth gear 454, the fourth gear 454 on the rear side (YB direction side) of the front side plate is referred to as the front fourth gear 454 and the fourth gear 454 on the front side (YA direction side) of the rear side plate is referred to as the rear fourth gear 454.

The rear third gear 453 is fixed to the front side of the rear side plate at the rear end portion of the rotary shaft 43. The front third gear 453 is fixed to the rear side of the front side plate at the front end portion of the rotary shaft 43. Therefore, the rear third gear 453 and the front third gear 453 rotate in the same direction as the rotary shaft 43.

The rear fourth gear 454 is an idler gear provided in the transmission path between the rear third gear 453 and the gear portion 412 of the rear pressing member 41. The rear fourth gear 454 is rotatably attached to a rotary support shaft 456 protruding from the rear side plate in the YA direction.

The front fourth gear 454 is an idler gear provided in the transmission path between the front third gear 453 and the gear portion 412 of the front pressing member 41. The front fourth gear 454 is rotatably attached to the rotary support shaft 456 protruding from the front side plate in the YB direction.

According to the drive transmission unit 45 having such a configuration, when the drive motor 46 rotates, the pressing members 41 rotate in synchronization with each other in the same direction. Therefore, the pressing member 41 swings around the central axis O in response to the forward and reverse rotation of the drive motor 46. That is, the central axis O is a swing axis that extends in the Y direction in the horizontal direction and swings the cam plate portion 411 of the pressing member 41.

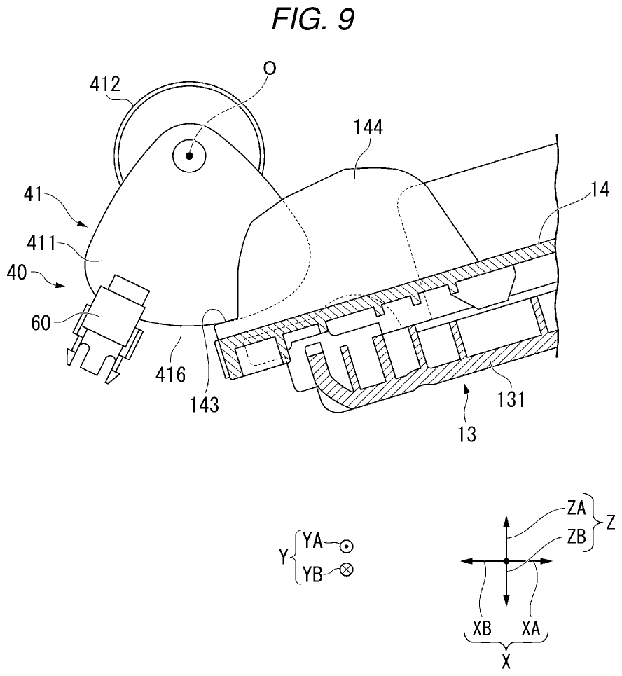

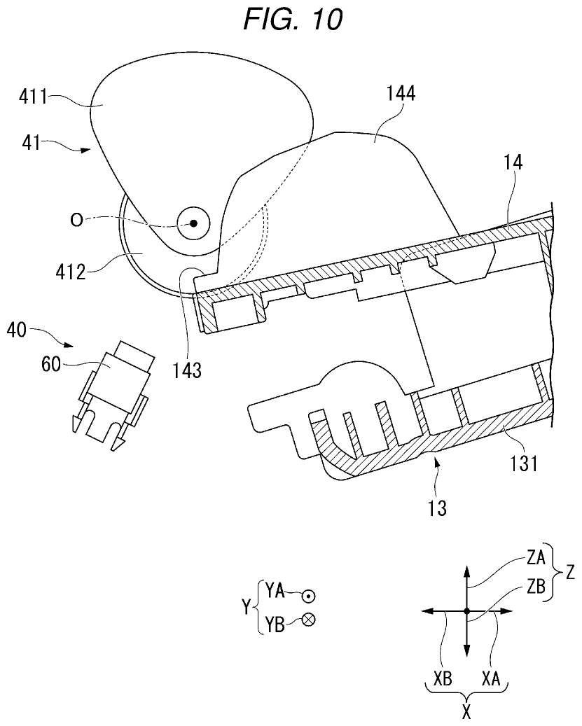

FIG. 9 is a schematic diagram for illustrating the position of the cam (cam-down position) in the descended position of the elevating plate of the first embodiment. Here, the cam-down position means a position where the cam plate portion faces downward. FIG. 10 is a schematic diagram for illustrating the position of the cam (cam-up position) in the ascending position of the elevating plate of the first embodiment. Here, the cam-up position means a position where the cam plate portion faces upward.

The elevating mechanism 40 includes a position detection sensor 60 that detects the swing position of the pressing member 41. For example, the position detection sensor 60 detects the most clockwise swing position and the most counterclockwise swing position of the pressing member 41 when viewed from the YB direction and sends the detected signal to the control unit 6 described later.

The most clockwise swing position is the position where the cam plate portion 411 faces downward and the elevating plate 14 is pushed down to the descended position (see FIG. 9). The most clockwise swing position is the home position of the pressing member 41.

The most counterclockwise swing position is the position where the cam plate portion 411 faces upward and is separated from the most raised elevating plate 14 (see FIG. 10).

As shown in FIG. 1, the control unit 6 controls the entire image forming apparatus 100 and each device portion. For example, the control unit 6 controls the control panel 1, the scanner unit 2, the printer unit 3, the sheet supply unit 4, the conveyance unit 5, and the manual feed unit 10 to convey the sheet S and form an image on the sheet S.

For example, the control unit 6 sends a control signal to the drive motor 46 (see FIG. 5) in the manual feed unit 10 to control the ascending and descending of the elevating plate 14.

As the device configuration of the control unit 6, for example, a processor such as a central processing unit (CPU) may be used.

Next, the operation of the image forming apparatus 100 will be described focusing on the ascending and descending operation of the elevating plate 14 and the swinging operation of the pressing member 41 in the manual feed tray 13.

First, the image forming operation of the image forming apparatus 100 will be briefly described.

In the image forming apparatus 100 shown in FIG. 1, image forming is started by the operation of the control panel 1 or an external signal. The image information is read from an object to be copied by the scanner unit 2 and transmitted to the printer unit 3 or is transmitted from the outside to the printer unit 3. The printer unit 3 supplies the sheet S in the sheet supply unit 4 or the sheet S in the manual feed unit 10 to the registration rollers 24 based on the control signal generated by the control unit 6 based on the operation of the control panel 1 or the external signal. Hereinafter, as an example, a case where the sheet S in the sheet supply unit 4 is supplied will be described. The set of the sheet S in the manual feed unit 10 will be described later.

When an operation input for image formation is made from the control panel 1, the control unit 6 controls to start sheet feeding and image formation from the sheet supply unit 4.

The image forming units 251, 252, 253, and 254 form an electrostatic latent image on each photoconductor drum 7 based on the image information corresponding to each color. Each electrostatic latent image is developed by the developing device 8. Therefore, a toner image corresponding to the electrostatic latent image is formed on the surface of each photoconductor drum 7.

Each toner image is primarily transferred to the intermediate transfer belt 27 by each transfer roller. As the intermediate transfer belt 27 moves, the toner images are sequentially superposed without causing color shift and sent to the transfer unit 28.

The sheet S is fed from the registration rollers 24 to the transfer unit 28. The toner image that reached the transfer unit 28 is secondarily transferred to the sheet S. The secondary transferred toner image is fixed to the sheet S by the fixing device 29. As a result, an image is formed on the sheet S.

Next, the operation of the manual feed tray 13 will be described in detail.

In order to place the sheet S on the manual feed tray 13, as shown in FIG. 4, the elevating plate 14 needs to be arranged in the descended position. On the other hand, in order to feed the sheet S toward the conveyance unit 5 to form an image on the sheet S placed on the manual feed tray 13, it is necessary to raise the elevating plate 14 to a position where the pickup roller 121 can come into contact with the uppermost surface of the sheet S.

FIG. 7 is a schematic diagram for illustrating the descended position of the elevating plate of the first embodiment. FIG. 8 is a schematic diagram for illustrating the ascending position of the elevating plate of the first embodiment.

As shown in FIG. 7, in order to arrange the elevating plate 14 in the descended position, the cam surface 416 of each pressing member 41 needs to be moved to the lower first position by being rotated clockwise in the drawing. At this time, the cam surface 416 pushes down each cam contact surface 143 of the elevating plate 14. The biasing member 16 (see FIG. 3) arranged between the bottom plate 131 and the elevating plate 14 is compressed by the pressing pressure from each pressing member 41.

In such a descended position of the elevating plate 14, the cam surface 416 at the first position has a substantially central portion in the circumferential direction in contact with each cam contact surface 143.

In the drawing shown in FIG. 7, the front pressing member 41 is pushing down the cam contact surface 143 on the front side of the elevating plate 14.

On the other hand, in order to raise the elevating plate 14 to a position where a sheet can be fed, as shown in FIG. 8, the cam surface 416 of each pressing member 41 needs to move upward by being rotated counterclockwise in the drawing. The cam surface 416 is rotatable up to a second position above the first position as shown in FIG. 8. The cam surface 416 is separated from each cam contact surface 143 of the elevating plate 14 by the time the swing from the first position to the second position is completed.

The elevating plate 14 is raised to a position where the sheet S (not shown) can come into contact with the pickup roller 121 (see FIG. 2) due to the elastic restoring force of the biasing member 16 (see FIG. 3).

The elevating plate 14 shown in FIG. 8 is drawn with the highest ascending position when the sheet S is not placed. At this time, the cam contact surface 143 enters the recess 415 of the pressing member 41 that moved to the second position and rises to the vicinity of the step portion 414. A gap is formed between the step portion 414 and the tip portion of the elevating plate 14 in the XB direction.

Here, the appearance of the side cover 18 at the descended position of the elevating plate 14 will be described.

As shown in FIG. 4, the side cover 18 covers the elevating mechanism 40 (see FIG. 5) except for a part at the upper side of the sheet feed opening 182 and both end portions in the Y direction. The side cover 18 includes a side cover portion 184 extending in the Y direction above the sheet feed opening 182. The side cover portion 184 covers the entire rotary shaft 43 (see FIG. 5) of the elevating mechanism 40. As a result, the user cannot touch the rotary shaft 43 from the outside of the side cover 18.

Next, the appearance of the side cover 18 will be described with reference to the vicinity of the end portion of the sheet feed opening 182 in the YB direction.

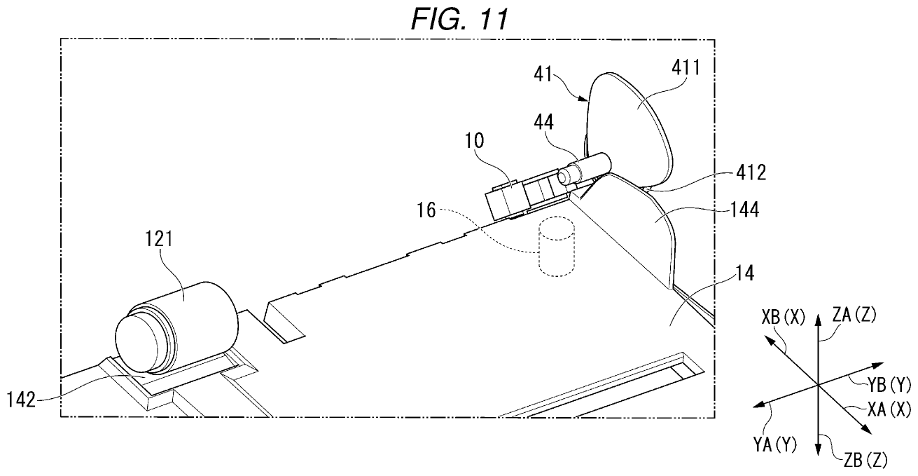

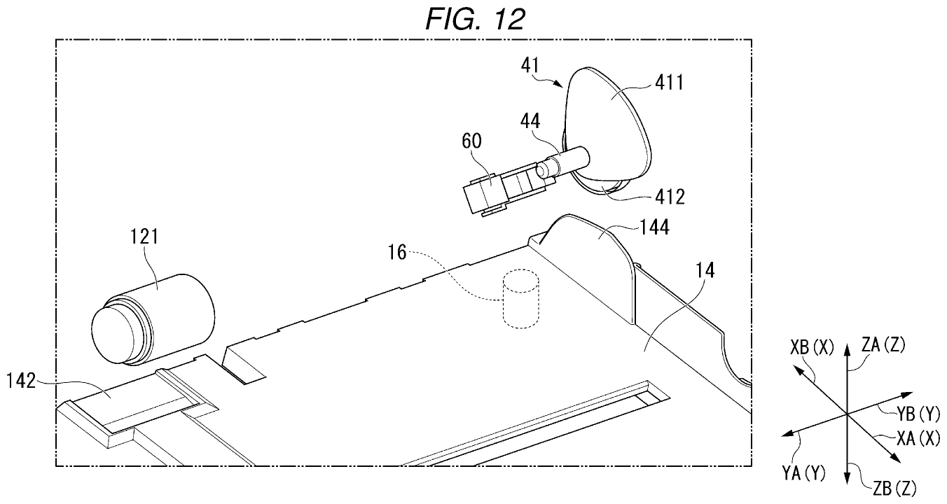

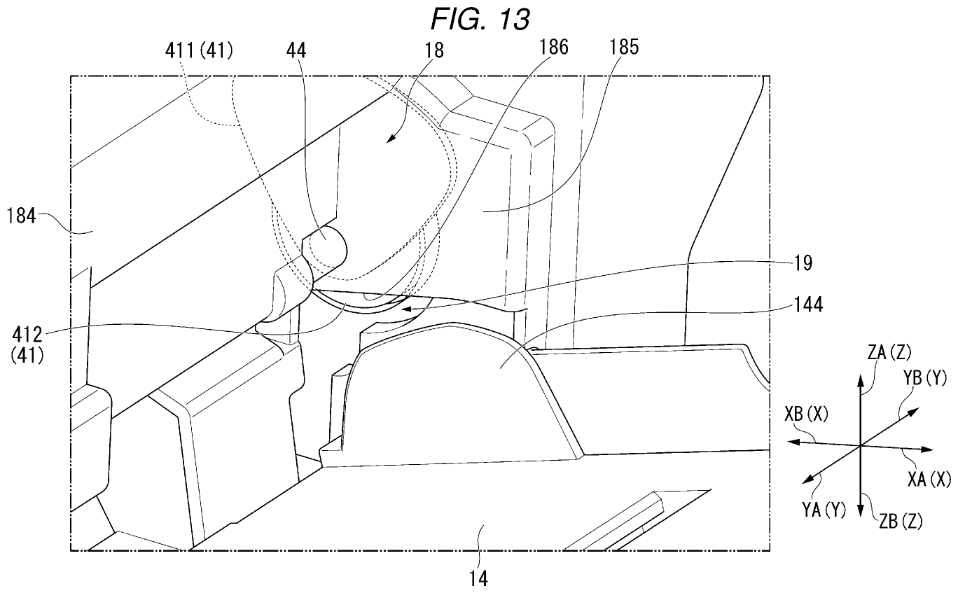

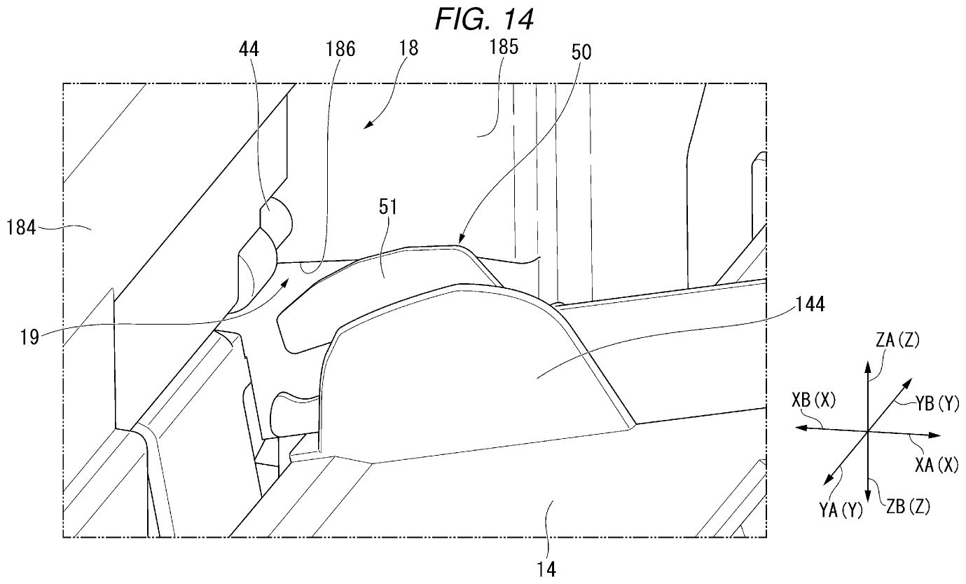

FIG. 11 is a perspective view for illustrating a cam-up position in the ascending position of the elevating plate of the first embodiment. FIG. 12 is a perspective view for illustrating a state in which the elevating plate is pushed down against the biasing force of the biasing member from the state of the cam-up position in the ascending position of the elevating plate of the first embodiment. FIG. 13 is a perspective view for illustrating the position of a shutter in the state of the cam-up position in the ascending position of the elevating plate of the first embodiment. FIG. 14 is a perspective view for illustrating the position of the shutter in the state of the cam-up position in the descended position of the elevating plate of the first embodiment. FIGS. 13 and 14 show the vicinity of the end portion of the sheet feed opening 182 (see FIG. 4) in the YB direction.

As shown in FIG. 11, the elevating plate 14 is arranged in the ascending position in a state of being biased upward by the biasing member 16. For example, the user can push down the elevating plate with the user's finger from the state of FIG. 11 to make the state of FIG. 12. That is, while maintaining the cam-up position shown in FIG. 11, the elevating plate 14 arranged at the ascending position can be placed on the descended position shown in FIG. 12. As shown in FIG. 13, for example, inner cover portions 185 are formed at both end portions of the side cover portion 184 in the Y direction. FIG. 13 shows the inner cover portion 185 in the YB direction.

The inner cover portion 185 is a plate-shaped portion that covers the periphery of the rotary support shaft 44 and extends along the ZX plane. The inner cover portion 185 covers a part of the rear pressing member 41 at the cam-up position from the YA direction side. Specifically, the inner cover portion 185 covers the cam plate portion 411 at the cam-up position as a whole from the YA direction side. A gap that opens in the Y direction is formed below the inner cover portion 185. A part of the gear portion 412 at the cam-up position is exposed from the gap. This gap is large enough that a user's finger cannot enter, for example. For example, the size of the gap is about 2 mm or less.

As shown in FIG. 13, the inner cover portion 185 is arranged above the plate-shaped protrusion 144. At the lower end portion of the inner cover portion 185, a lower end surface 186 extending in the X direction is formed below the rotary support shaft 44. With such a configuration, an opening 19 that opens in the Y direction is formed in the region below the lower end surface 186. The opening 19 is kept in a size that does not allow a user's finger to enter by the operation of a shutter 50 (shielding member) described later and the elevating plate 14.

The above-mentioned inner cover portion 185 is similarly provided at the end portion of the side cover portion 184 in the YA direction. The inner cover portion 185 in the YA direction similarly covers the front pressing member 41 (see FIG. 5) in the YA direction. The configuration of the inner cover portion 185 in the YA direction is plane-symmetric with respect to the ZX plane with the inner cover portion 185 in the YB direction described above. Regarding the configuration of the inner cover portion 185 in the YA direction, the YB direction may be read as the YA direction in the above description.

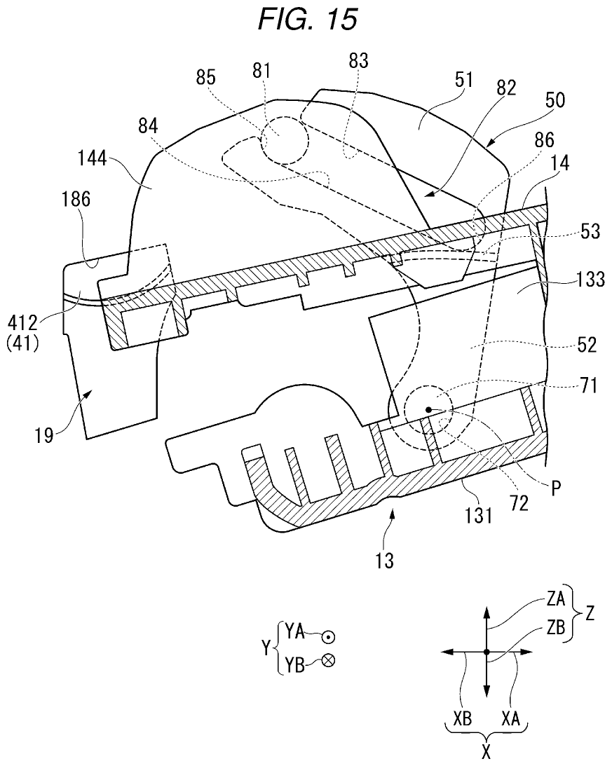

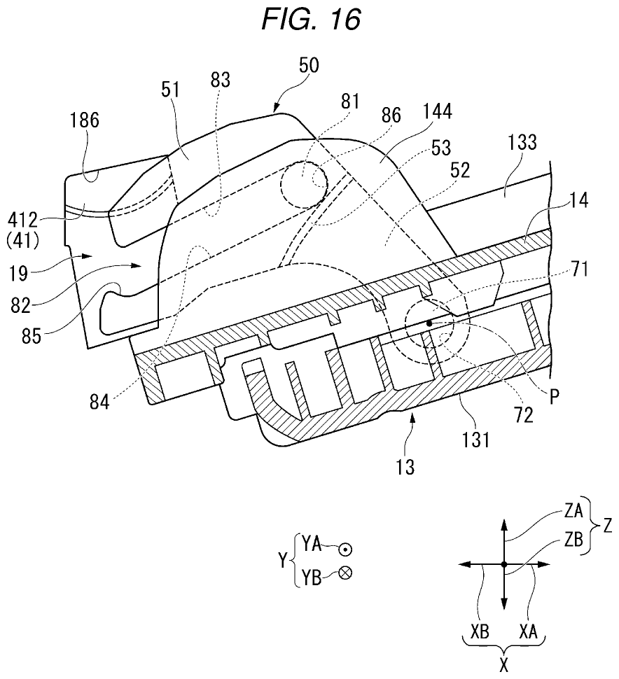

Next, the shutter will be described. FIG. 15 is a schematic diagram for illustrating the position of the shutter with respect to the gap in the ascending position of the elevating plate of the first embodiment. FIG. 16 is a schematic diagram for illustrating the position of the shutter with respect to the gap at the descended position of the elevating plate of the first embodiment. In addition, FIGS. 15 and 16 show examples of the cam-up position.

The shutters 50 are arranged adjacent to each other on the outside (front side and rear side) of the elevating plate 14 in the Y direction. The shutter 50 is arranged between the plate-shaped protrusion 144 of the elevating plate 14 and the pressing member 41 in the Y direction. FIG. 15 shows only the shutter 50 adjacent to the rear side (YB direction side) of the elevating plate 14 in the Y direction (the shutter 50 arranged between the plate-shaped protrusion 144 on the rear side of the elevating plate 14 and the rear pressing member 41). When it is necessary to distinguish each shutter 50, the shutter 50 on the front side (YA direction side) is referred to as the front shutter 50, and the shutter 50 on the rear side (YB direction side) is referred to as the rear shutter 50.

The front shutter 50 and the rear shutter 50 have shapes that are plane-symmetric with respect to the ZX plane at the center of their respective arrangement positions. Therefore, in the following, an example of the rear shutter 50 will be described. As for the shape of the front shutter 50, the YB direction of the following description regarding the rear shutter 50 may be read as the YA direction.

As shown in FIG. 15, the rear shutter 50 includes a shielding portion 51 and an arm portion 52. A step portion 53 is formed between the shielding portion 51 and the arm portion 52 to prevent the rear shutter 50 from interfering with peripheral members. The step portion 53 extends over the boundary portion between the shielding portion 51 and the arm portion 52. In the state of FIG. 15, the step portion 53 is arranged above the upper end of the rear side plate 133 of the manual feed tray 13.

The rear shutter 50 is rotatably provided about an axis P extending in the Y direction in the horizontal direction. The axis P is a swing axis that swings between a position where the rear shutter 50 shields a part of the rear pressing member 41 (see FIG. 16) and a position where the rear shutter 50 does not shield the rear pressing member 41 (see FIG. 15).

The rear shutter 50 and the manual feed tray 13 include rotary support members 71 and 72 that are rotatably supported by each other. In the example shown in FIG. 15, the rotation support members 71 and 72 are a protrusion 71 provided on the rear shutter 50 and a through hole 72 provided on the rear side plate 133 of the manual feed tray 13. The protrusion 71 projects in the YA direction from the end portion of the arm portion 52 of the rear shutter 50 opposite to the step portion 53. The through hole 72 has a circular shape that opens the portion of the rear side plate 133 on the XB direction side in the Y direction. For example, the protrusion 71 is a columnar convex portion having an outer diameter substantially the same as the inner diameter of the through hole 72. With the protrusion 71 inserted into the through hole 72, the rear shutter 50 can swing around the axis P.

However, such a mode of the rotation support member is an example. For example, the rotation support member is not limited to the above example and may be a protrusion provided on the rear side plate 133 of the manual feed tray 13 and a through hole provided on the rear shutter 50. The protrusion is not limited to a columnar convex portion and may have a pair of arc-shaped portions along the inner diameter of the through hole 72. Further, the portion into which the protrusion is inserted is not limited to the through hole and may be a recess. The mode of the rotation support member can be changed according to the required specifications.

The arm portion 52 is formed in a plate shape along the ZX plane. In the state of FIG. 15, the arm portion 52 extends from the portion overlapping the axis P upward than the upper end of the rear side plate 133 of the manual feed tray 13.

The shielding portion 51 is formed in a plate shape along the ZX plane at a position offset in the Y direction with respect to the arm portion 52. The shielding portion 51 extends bifurcated from a portion (step portion 53) opposite to the portion overlapping the axis P in the direction in which the arm portion 52 extends. In the state of FIG. 15, the shielding portion 51 is inclined so as to be located upward toward the XB direction side from the step portion 53.

The elevating plate 14 and the rear shutter 50 include engaging members 81 and 82 that engage with each other in the ascending and descending operation of the elevating plate 14. In the example of FIG. 15, the engaging members 81 and 82 are a protrusion 81 provided on the elevating plate 14 and a rail 82 provided on the rear shutter 50.

The protrusion 81 projects in the YB direction from the surface of the plate-shaped protrusion 144 of the elevating plate 14 on the YB direction side. The protrusion 81 is formed in a columnar shape extending in the Y direction.

The rail 82 includes two walls 83 and 84 sandwiching the protrusion 81. The two walls 83 and 84 are arranged at intervals substantially the same as the outer diameter of the protrusion 81, respectively. The two walls 83 and 84 extend linearly in parallel with each other when viewed from the Y direction. In the state where the protrusion 81 is arranged in the rail 82, the protrusion 81 can move along the rail 82.

The rail 82 includes two contact portions 85 and 86 to which the protrusion 81 can come into contact. The two contact portions 85 and 86 are a first contact portion 85 provided on the open end side of the rail 82 and a second contact portion 86 provided on the rail 82 near the arm portion 52 (step portion 53).

The first contact portion 85 is a portion where the protrusion 81 abuts at the ascending position (see FIG. 15) of the elevating plate 14. The first contact portion 85 is formed in an arc shape along the outer diameter of the protrusion 81 when viewed from the Y direction.

The second contact portion 86 is a portion where the protrusion 81 abuts at the descended position (see FIG. 16) of the elevating plate 14. The second contact portion 86 is formed in an arc shape along the outer diameter of the protrusion 81 when viewed from the Y direction. The second contact portion 86 connects the portions of the two walls 83 and 84 opposite to the open end of the rail 82. With the protrusion 81 arranged in the rail 82, the protrusion 81 can move between the first contact portion 85 and the second contact portion 86.

For example, when the elevating plate 14 moves from the ascending position to the descended position (when moving from the position shown in FIG. 15 to the position shown in FIG. 16), the protrusion 81 moves from the first contact portion 85 toward the second contact portion 86 while pushing down one of the two walls 83 and 84 (hereinafter, referred to as “lower wall 84”).

On the other hand, when the elevating plate 14 moves from the descended position to the ascending position (when moving from the position shown in FIG. 16 to the position shown in FIG. 15), the protrusion 81 moves from the second contact portion 86 toward the first contact portion 85 while pushing up the other of the two walls 83 and 84 (hereinafter, referred to as “upper wall 83”).

Next, the operations of the pressing member 41 and the shutter 50 will be described with an example of the rear pressing member 41 and the rear shutter 50. The operations of the front pressing member 41 and the front shutter 50 are the same as those of the rear pressing member 41 and the rear shutter 50, although not particularly illustrated.

FIG. 9 is a schematic diagram for illustrating the position of the cam (cam-down position) in the descended position of the elevating plate of the first embodiment. FIG. 10 is a schematic diagram for illustrating the position of the cam (cam-up position) in the ascending position of the elevating plate of the first embodiment. FIG. 15 is a schematic diagram for illustrating the position of the shutter with respect to the gap in the ascending position of the elevating plate of the first embodiment. FIG. 16 is a schematic diagram for illustrating the position of the shutter with respect to the gap at the descended position of the elevating plate of the first embodiment. FIGS. 9, 10, 15, and 16 are all diagrams viewed from the YB direction. In the following, unless otherwise specified, the rotational directions of the pressing member 41 and the shutter 50 described in FIGS. 9, 10, 15, and 16 will be described in the clockwise and counterclockwise directions in the drawings.

As shown in FIG. 9, when the elevating plate 14 is located in the descended position, the rear pressing member 41 is moved to the home position. In the home position, the cam surface 416 is located in the first position. The cam surface 416 is in contact with the cam contact surface 143 of the elevating plate 14. The elevating plate 14 is biased upward by the biasing member 16 (see FIG. 3).

Although not shown, when the elevating plate 14 is located in the descended position, the cam plate portion 411 of the rear pressing member 41 faces downward in the cam-down position, and thus, most of the opening 19 is closed by the cam plate portion 411. On the other hand, when the elevating plate 14 is located in the descended position, the cam plate portion 411 of the rear pressing member 41 faces upward at the cam-up position (the gear portion 412 of the rear pressing member 41 faces downward), and thus, the opening 19 is closed by the gear portion 412. However, when the elevating plate 14 is located in the descended position, the opening 19 cannot be completely closed by the rear pressing member 41 at the cam-up position and a gap is partially formed (see FIG. 16).

In this embodiment, as shown in FIG. 16, when the elevating plate 14 is located in the descended position, the rear shutter 50 shields a part of the rear pressing member 41. Specifically, the end portion of the shielding portion 51 of the rear shutter 50 on the XB direction side is located lower than when the elevating plate 14 is located in the ascending position (see FIG. 15). As a result, the shielding portion 51 covers the opening region between the lower end surface 186 and the plate-shaped protrusion 144 in the opening 19 from the YB direction.

The arrangement of the shielding portion 51 arranged in this way is referred to as a shielding position because the shielding portion 51 overlaps with the region in the height direction occupied by the gear portion 412 of the rear pressing member 41 at the second position when viewed from the YB direction.

As shown in FIG. 16, when the elevating plate 14 is located in the descended position, the protrusion 81 is in contact with the second contact portion 86 in the rail 82. When the elevating plate 14 moves from the descended position to the ascending position (when moving from the position shown in FIG. 16 to the position shown in FIG. 15), the protrusion 81 moves from the second contact portion 86 toward the first contact portion 85 while pushing up the upper wall 83. Therefore, the rear shutter 50 can rotate clockwise about the axis P within the range of the rail 82.

In the present embodiment, the swing direction in which the cam plate portion 411 moves from the first position to the second position (the direction in which the cam plate portion 411 swings from the position shown in FIG. 8 to the position shown in FIG. 7) is in the counterclockwise direction. The swing direction in which the cam plate portion 411 moves from the first position to the second position may be in the clockwise direction. For example, the swing direction of the cam plate portion 411 can be changed according to the required specifications.

Such a descended position of the elevating plate 14 is automatically formed by the control of the control unit 6 when the manual feed tray 13 is opened. That is, when the control unit 6 detects that the manual feed tray 13 is opened, the control unit 6 refers to the detection signal of the position detection sensor 60 (see FIG. 9) of the rear pressing member 41. When the rear pressing member 41 is out of the home position by the detection output, the control unit 6 drives the drive motor 46 to rotate each pressing member 41 to the home position. Each pressing member 41 moves the elevating plate 14 to the descended position by the cam plate portion 411 pushing down the elevating plate 14.

When the elevating plate 14 moves to the descended position, the user can place the sheet S on the upper surface of the manual feed tray 13.

When the image formation start signal is generated by the operation of the control panel 1 or an external signal, the control unit 6 sends a control signal for rotating the pressing member 41 upward to the drive motor 46.

For example, as shown in FIG. 10, as the rear pressing member 41 rotates counterclockwise, the elevating plate 14 reaches the ascending limit. At this time, the cam plate portion 411 is separated upward from the cam contact surface 143. Here, the ascending limit of the elevating plate 14 differs depending on the loading height of the sheets S. For example, when the sheet S is not placed, the elevating plate 14 stops at the highest ascending position of the elevating plate 14 itself.

For example, in the example shown in FIG. 10, the elevating plate 14 reaches the ascending limit. When the elevating plate 14 reaches the ascending limit, the cam plate portion 411 of the rear pressing member 41 moves inside the side cover 18 (see FIG. 13).

For example, when the rear pressing member 41 reaches the most counterclockwise swing position, the position detection sensor 60 (see FIG. 9) sends a detection signal to the control unit 6. Upon receiving this detection signal, the control unit 6 sends a control signal to the drive motor 46 to stop the rotation of the drive motor 46.

As shown in FIG. 15, when the elevating plate 14 is located in the ascending position, the rear shutter 50 is completely rotated clockwise about the axis P. At this time, the protrusion 81 is in contact with the first contact portion 85 in the rail 82. The elevating plate 14 shields the rear pressing member 41 when the elevating plate 14 is located in the ascending position. The rear shutter 50 does not shield the rear pressing member 41 when the elevating plate 14 is located in the ascending position.

Meanwhile, the user can push down the elevating plate 14 with the user's finger from the state of FIG. 11 (the ascending position of the elevating plate 14) to make the state of FIG. 12 (the descended position of the elevating plate 14). For example, when the elevating plate 14 moves from the ascending position to the descended position (when moving from the position shown in FIG. 15 to the position shown in FIG. 16), the protrusion 81 moves from the first contact portion 85 toward the second contact portion 86 while pushing down the lower wall 84. Therefore, the rear shutter 50 can rotate counterclockwise around the axis P within the range of the rail 82.

As shown in FIG. 15, the opening 19 is covered with a plate-shaped protrusion 144 that rose together with the elevating plate 14. Therefore, even when the elevating plate 14 is in the ascending position, the opening 19 does not have a gap through which the user's finger can be inserted.

As shown in FIG. 16, the opening 19 is covered by the shielding portion 51 of the rear shutter 50. Therefore, even when the elevating plate 14 is in the descended position, the opening 19 does not have a gap through which the user's finger can be inserted.

In this way, when the elevating plate 14 moves to the ascending position, the sheet S is fed and image formation is performed. When the sheet feeding required for image formation is completed, the control unit 6 moves the elevating plate 14 to the descended position.

The movement of the elevating plate 14 from the ascending position to the descended position is performed in the reverse order of the above by the control unit 6 reversing the drive motor 46.

When the rear pressing member 41 rotates clockwise and the elevating plate 14 moves to the descended position, as shown in FIG. 16, the rear shutter 50 returns to the position to cover the opening 19 in a state where there is no gap for inserting the user's finger.

As described above, the image forming apparatus 100 of the present embodiment includes the image forming units 251 to 254, the sheet feed unit 10, the sheet tray 13, the elevating plate 14, the pressing member 41, and the shutter 50. The image forming units 251 to 254 form an image on the sheet S. The sheet feed unit 10 supplies the sheet S to the image forming units 251 to 254. The sheet tray 13 is provided in the sheet feed unit 10. The sheet S is placed on the sheet tray 13. The elevating plate 14 is arranged on the sheet tray 13. The elevating plate 14 can be ascended and descended between the descended position in which the sheet S is set and the ascending position higher than the descended position. The pressing member 41 is movable between the first position in which the elevating plate 14 is arranged in the descended position and the second position in which the elevating plate 14 can be moved to the ascending position. The shutter 50 is interlocked with the ascending and descending operation of the elevating plate 14. The shutter 50 shields the pressing member 41 when the elevating plate 14 is in the descended position.

According to the image forming apparatus 100 of the present embodiment, the shutter 50 shields the pressing member 41 at the descended position of the elevating plate 14. Therefore, it is possible to provide the image forming apparatus 100 capable of reducing the opening 19 around the pressing member 41.

In the meantime, the user can push down the elevating plate 14 with the user's finger from the state of FIG. 11 (the ascending position of the elevating plate 14) to make the state of FIG. 12 (the descended position of the elevating plate 14). If the opening around the pressing member is too large, the user's finger may enter the exposed portion of the pressing member, or the finger may be pinched in the opening. On the other hand, according to the image forming apparatus 100 of the present embodiment, as shown in FIG. 16, the shutter 50 shields the pressing member 41 at the descended position of the elevating plate 14, and thus, the opening around the pressing member 41 is kept reduced. Therefore, in the ascending and descending operation of the elevating plate 14, it is possible to prevent the user's finger from entering the exposed portion of the pressing member 41 or prevent the finger from being pinched in the opening 19.

In particular, in the present embodiment, since the shutter 50 rotates in conjunction with the ascending and descending operation of the elevating plate 14, it is not necessary to provide a dedicated drive mechanism for rotating the shutter 50. Therefore, the opening 19 around the pressing member 41 can be reduced with a simple structure.

The elevating plate 14 has the following effects by shielding the pressing member 41 when the elevating plate 14 is located in the ascending position.

Since the elevating plate 14 shields the pressing member 41 at the ascending position of the elevating plate 14, the opening 19 around the pressing member 41 can be reduced. As a result, the shutter 50 shields the pressing member 41 at the descended position of the elevating plate 14 and the elevating plate 14 itself shields the pressing member 41 at the ascending position of the elevating plate 14, and thus, when the elevating plate 14 is raised and lowered (that is, when the elevating plate 14 is raised and when the elevating plate 14 is lowered, respectively), the opening 19 around the pressing member 41 can be reduced.

The shutter 50 has the following effects by not shielding the pressing member 41 when the elevating plate 14 is in the ascending position.

Since the shutter 50 is retracted from the opening 19 around the pressing member 41 at the ascending position of the elevating plate 14, for example, the elevating plate 14 or the like can advance into the opening 19 around the pressing member 41.

The shutter 50 is provided so as to be rotatable around the axis P extending horizontally and thus has the following effects.

In order to rotate the shutter 50 in conjunction with the ascending and descending operation of the elevating plate 14, it is not necessary to provide a dedicated rotation switching mechanism for switching the rotation direction of the shutter 50. Therefore, with a simple configuration, the shutter 50 can be rotated in conjunction with the ascending and descending operation of the elevating plate 14.

The elevating plate 14 and the shutter 50 have the following effects by including engaging members 81 and 82 that engage with each other in the ascending and descending operation of the elevating plate 14.

As compared with the case where the engaging members 81 and 82 are provided separately from the elevating plate 14 and the shutter 50, the shutter 50 can be rotated in conjunction with the ascending and descending operation of the elevating plate 14 with a simple structure.

The engaging members 81 and 82 have the following effects by including the protrusion 81 provided on the elevating plate 14 and the rail 82 provided on the shutter 50 and including two walls 83 and 84 sandwiching the protrusion 81.

When the protrusion 81 moves in the rail 82 in the ascending and descending operation of the elevating plate 14, the shutter 50 moves according to the ascending and descending operation of the elevating plate 14. Therefore, the shutter 50 can be interlocked with the ascending and descending operation of the elevating plate 14 with a simple configuration.

The protrusion 81 is formed in a columnar shape. The two walls 83 and 84 extend parallel to each other. With the above configuration, the following effects are obtained.

Since the protrusion 81 moves smoothly in the rail 82 in the ascending and descending operation of the elevating plate 14, the shutter 50 can be smoothly interlocked with the ascending and descending operation of the elevating plate 14.

Since the sheet tray 13 is a manual feed tray, the following effects are obtained.

It is possible to provide the image forming apparatus 100 capable of reducing the opening 19 around the pressing member 41 when the elevating plate 14 is raised and lowered in manual sheet feeding.

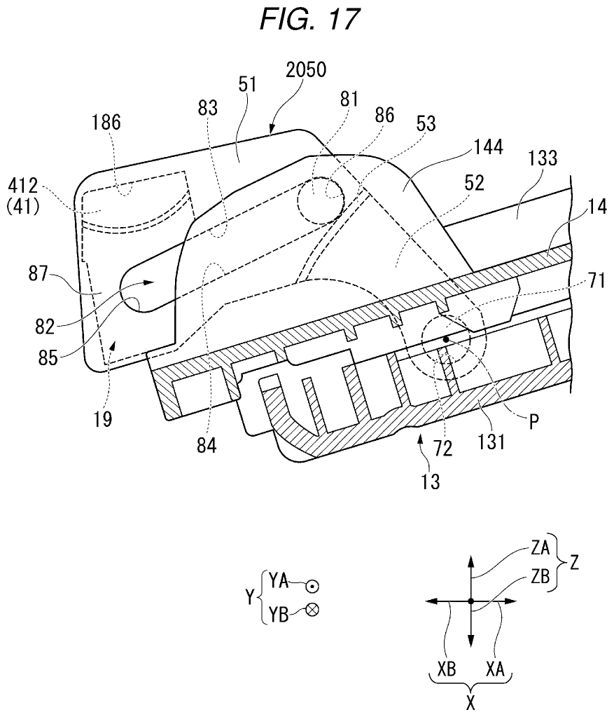

Next, a second embodiment will be described with reference to FIG. 17. In the second embodiment, the description of the same configurations as those of the first embodiment will be omitted.

As shown in FIG. 15, in the shutter 50 of the first embodiment, the portions on the side of the pressing member 41 are separated from each other in the two walls 83 and 84. On the other hand, as shown in FIG. 17, a shutter 2050 of the second embodiment is different from the first embodiment in that the portions on the side of the pressing member 41 are connected to each other in the two walls 83 and 84.

FIG. 17 is a schematic diagram for illustrating the position of the shutter with respect to the gap at the descended position of the elevating plate of the second embodiment. FIG. is a drawing corresponding to FIG. 16 of the first embodiment.

As shown in FIG. 17, the shutter 2050 includes a connecting portion 87 that connects the portions on the side of the pressing member 41 to each other in the two walls 83 and 84. The shutter 2050 entirely shields the pressing member 41 when the elevating plate 14 is in the descended position. The shutter 2050 is formed in a shape along the outer edge of the opening 19 except for the inner portion of the rail 82 when the elevating plate 14 is located in the descended position. The opening 19 is substantially covered by a shielding portion 2051 of the shutter 2050. Therefore, even when the elevating plate 14 is in the descended position, the opening 19 does not have a gap through which the user's finger can be inserted.

According to the second embodiment, the following effects are obtained by connecting the portions on the side of the pressing member 41 to each other in the two walls 83 and 84.

In the descended position of the elevating plate 14, as compared with the case where the portions on the side of the pressing member 41 are separated from each other in the two walls 83 and 84 (see FIG. 16), the connecting portion 87 of the shutter 2050 shields the opening 19, and thus, the opening around the pressing member 41 can be reduced more effectively.

The shutter 2050 has the following effects by entirely shielding the pressing member 41 when the elevating plate 14 is in the descended position.

Since the shutter 2050 entirely shields the pressing member 41 at the descended position of the elevating plate 14, the opening 19 around the pressing member 41 can be reduced as much as possible.

Next, a modification of the embodiment will be described.

The elevating plate is not limited to shielding the pressing member when the elevating plate is located in the ascending position. For example, the elevating plate may not shield the pressing member when the elevating plate is located in the ascending position. For example, the mode of the arrangement of the elevating plate with respect to the pressing member can be changed according to the required specifications.

The shutter is not limited to not shielding the pressing member when the elevating plate is in the ascending position. For example, the shutter may shield the pressing member when the elevating plate is in the ascending position. For example, the mode of arrangement of the shutter with respect to the pressing member can be changed according to the required specifications.

The shutter is not limited to being provided so as to be rotatable around an axis extending horizontally. For example, the shutter may be rotatably provided about an axis extending in a direction intersecting the horizontal direction. For example, the mode of the rotation axis (swing axis) of the shutter can be changed according to the required specifications.

The elevating plate and the shutter are not limited to including engaging members that engage with each other in the ascending and descending operation of the elevating plate. For example, the engaging member may be provided separately from the elevating plate and the shutter. For example, the mode of the engaging member can be changed according to the required specifications.

The engaging member is not limited to including a protrusion provided on the elevating plate and a rail provided on the shutter and including two walls sandwiching the protrusion. For example, the engaging member may be a protrusion provided on the shutter and a rail provided on the elevating plate. For example, the mode of the arrangement of the protrusion and the rail can be changed according to the required specifications.

The protrusion is not limited to being formed in a columnar shape. For example, the protrusion may have a pair of arcuate portions. Also, the two walls are not limited to extending parallel to each other. For example, the two walls may extend in a direction intersecting each other. Further, the portion (inside the rail) into which the protrusion is inserted is not limited to the through hole but may be a recess. The mode of the engaging member can be changed according to the required specifications.

The sheet tray is not limited to the manual feed tray. For example, the sheet tray may be a tray other than the manual feed tray. For example, the mode of the sheet tray can be changed according to the required specifications.

According to at least one embodiment described above, the image forming apparatus 100 includes the image forming units 251 to 254, the sheet feed unit 10, the sheet tray 13, the elevating plate 14, the pressing member 41, and the shutter 50. The image forming units 251 to 254 form an image on the sheet S. The sheet feed unit 10 supplies the sheet S to the image forming units 251 to 254. The sheet tray 13 is provided in the sheet feed unit 10. The sheet S is arranged on the sheet tray 13. The elevating plate 14 is arranged on the sheet tray 13. The elevating plate 14 can be ascended and lowered between the descended position in which the sheet S is set and the ascending position higher than the descended position. The pressing member 41 is movable between the first position in which the elevating plate 14 is arranged in the descended position and the second position in which the elevating plate 14 can be moved to the ascending position. The shutter 50 is interlocked with the ascending and descending operation of the elevating plate 14. The shutter 50 shields the pressing member 41 when the elevating plate 14 is in the descended position.

According to the image forming apparatus 100 of the embodiment, the shutter 50 shields the pressing member 41 at the descended position of the elevating plate 14. Therefore, it is possible to provide the image forming apparatus 100 capable of reducing the opening 19 around the pressing member 41.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An image forming apparatus, comprising:
an image forming component configured to form an image on a sheet;
a sheet feeder configured to supply the sheet to the image forming component;
a sheet tray provided in the sheet feeder and on which the sheet is placed;
an elevating plate arranged on the sheet tray and configured to ascend and descend between a descended position where the sheet is set and an ascending position higher than the descended position;
a moving member movable between a first position where the elevating plate is in the descended position and a second position where the elevating plate can move to the ascending position; and
a shielding member interlocked with an ascending and descending operation of the elevating plate and configured to shield the moving member when the elevating plate is located at the descended position.

2. The image forming apparatus according to claim 1, wherein
the elevating plate shields the moving member when the elevating plate is located at the ascending position.

3. The image forming apparatus according to claim 1, with the proviso that the shielding member does not shield the moving member when the elevating plate is located at the ascending position.

4. The image forming apparatus according to claim 1, wherein
the shielding member is rotatably provided around an axis extending horizontally.

5. The image forming apparatus according to claim 1, wherein
the elevating plate and the shielding member comprise engaging members that engage with each other in the ascending and descending operation of the elevating plate.

6. The image forming apparatus according to claim 5, wherein
the engaging member comprises a protrusion provided on one of the elevating plate and the shielding member, and a rail provided on the other of the elevating plate and the shielding member and comprising two walls sandwiching the protrusion.

7. The image forming apparatus according to claim 6, wherein
the protrusion has a columnar shape, and
the two walls extend parallel to each other.

8. The image forming apparatus according to claim 6, wherein
in the two walls, the portions on the side of the moving member are connected to each other.

9. The image forming apparatus according to claim 1, wherein
the shielding member entirely shields the moving member when the elevating plate is located at the descended position.

10. The image forming apparatus according to claim 1, wherein
the sheet tray is a manual feed tray.

11. A sheet handling mechanism, comprising:
a sheet feeder configured to supply a sheet to an image forming component;
a sheet tray provided in the sheet feeder and on which a plurality of sheets are placed;
an elevating plate arranged on the sheet tray and configured to ascend and descend between a descended position where the sheet is set and an ascending position higher than the descended position;
a moving member movable between a first position where the elevating plate is in the descended position and a second position where the elevating plate can move to the ascending position; and
a shielding member interlocked with an ascending and descending operation of the elevating plate and configured to shield the moving member when the elevating plate is located at the descended position.

12. The sheet handling mechanism according to claim 11, wherein
the elevating plate shields the moving member when the elevating plate is located at the ascending position.

13. The sheet handling mechanism according to claim 11, with the proviso that the shielding member does not shield the moving member when the elevating plate is located at the ascending position.

14. The sheet handling mechanism according to claim 11, wherein
the shielding member is rotatably provided around an axis extending horizontally.

15. The sheet handling mechanism according to claim 11, wherein
the elevating plate and the shielding member comprise engaging members that engage with each other in the ascending and descending operation of the elevating plate.

16. The sheet handling mechanism according to claim 15, wherein
the engaging member comprises a protrusion provided on one of the elevating plate and the shielding member, and a rail provided on the other of the elevating plate and the shielding member and comprising two walls sandwiching the protrusion.

17. The sheet handling mechanism according to claim 16, wherein
the protrusion has a columnar shape, and
the two walls extend parallel to each other.

18. The sheet handling mechanism according to claim 16, wherein
in the two walls, the portions on the side of the moving member are connected to each other.

19. The sheet handling mechanism according to claim 11, wherein
the shielding member entirely shields the moving member when the elevating plate is located at the descended position.

20. The sheet handling mechanism according to claim 11, wherein
the sheet tray is a manual feed tray.
